(19) United States
(12) Patent Application Publication
(10) Pub. No.: US 2026/0350638 A1
(43) Pub. Date: Nov. 5, 2026

(54) SYSTEMS AND METHODS FOR VERIFYING AUTHENTICITY OF A PRODUCT USING RFID TECHNOLOGY

(71) Applicant: Walker Digital Table Systems, LLC, Las Vegas, NV (US)

(72) Inventors: Jay S. Walker, Ridgefield, CT (US); Evan Walker, Ridgefield, CT (US)

(21) Appl. No.: 19/745,118

(22) Filed: Jul. 17, 2026

Related U.S. Application Data
(63) Continuation of application No. PCT/US25/13277, filed on Jan. 27, 2025.
(60) Provisional application No. 63/624,894, filed on Jan. 25, 2024.

(51) Int. Cl. G06Q 30/018; G06K 7/10; G06Q 20/20

(52) U.S. Cl. CPC G06Q 30/0185; G06K 7/10297; G06Q 20/208

(57) ABSTRACT

Systems for utilizing RFID technology to verify an authenticity of an article being purchased, wherein the article embodies an RFID tag that has a first changeable state that can be set to either a locked status or an unlocked status and a second changeable state that can be set to either a paired status or an unpaired status, wherein the second state cannot be changed from an unpaired status to a paired status unless the first state is set to the unlocked status. In some embodiments, the first state is only operable to be changed by a certified retailer of the article and/or is changeable upon receiving a predetermined signal from a system of the certified retailer. In some embodiments, a retailer sets the first state to an unlocked state in order to allow the RFID tag to be paired with a user account of a purchaser of the article.

### CROSS REFERENCE TO RELATED APPLICATION(S)

The present application claims priority to, and the benefit of, PCT Application No. PCT/US 25/13277, filed Jan. 27, 2025 in the name of Walker et al. and titled SYSTEMS AND METHODS FOR VERIFYING AUTHENTICITY OF A PRODUCT USING RFID TECHNOLOGY, which PCT Application claims priority to U.S. Provisional Patent Application Ser. No. 63/624,894, filed Jan. 25, 2024 in the name of Walker et al and titled SYSTEMS AND METHODS FOR VERIFYING AUTHENTICITY OF PRODUCT USING RFID TECHNOLOGY. The entirety of each of these Applications is hereby incorporated herein by reference for all purposes.

### FIELD OF THE INVENTION

The present invention is directed to utilizing RFID technology to verify authentic sourcing of products that may be susceptible to counterfeiting.

### BACKGROUND

Radio Frequency Identification (RFID) technology is an effective tool for verifying the authenticity of products at various stages of manufacture, delivery and/or eventual transport to an end user. RFID technology has application in many industries including, for example, in the pharmaceutical, collectible, luxury goods, and electronics industries. Luxury brands use RFID tags to distinguish genuine products from counterfeit ones, while the pharmaceutical industry employs RFID to track the authenticity of drugs and prevent the distribution of counterfeit medicines. RFID technology provides businesses with unique identification capabilities which can combat counterfeiting and ensure consumer trust.

RFID technology uses electromagnetic fields to identify and track RFID tags which are attached to or embedded in objects. Each RFID tag contains a microchip and an antenna enabling the RFID tag to store and transmit data. The stored data includes a unique identifier (UID) which links the RFID tag to specific details about the product, such as its origin, production date, and serial number. The UID is stored in a database maintained by the manufacture or a third party provider. The RFID tag may be scanned with an RFID reader or scanner at various points during manufacture and distribution whereby the UID from the tag is cross-referenced with the database to confirm the authenticity of the product. RFID tags may be either active or passive. In general, the RFID reader emits a signal to activate the RFID tag. The scanned data, i.e., the UID, is obtained and transmitted to one or more databases for cross-referencing purposes to ensure authenticity.

RFID technology provides instantaneous access to product information, enabling real-time verification at any point or location in distribution and/or the in the supply chain. Some RFID systems allow end consumers to verify authenticity using smartphones equipped with RFID or Near Field Communication (NFC) features. In these applications, an imaging mechanism of the smartphone scans the RFID tag, enabling customers the ability to access product information directly from the database of the manufacturer or distributor.

RFID technology offers a robust solution for verifying the authenticity of products, enhancing supply chain transparency and consumer trust. Despite its challenges, ongoing advancements in RFID technology and declining costs are making it increasingly accessible for businesses across industries. By adopting RFID-based authentication systems, companies can not only protect their brand reputation but also contribute to a more secure and trustworthy marketplace.

### SUMMARY

Accordingly, the present invention is directed to further improvements in the use of RFID technology for product verification.

In accordance with one illustrative embodiment a system for authenticating an article comprises at least one RFID reader, a point-of-sale (POS) terminal communicatively coupled to the RFID reader, at least one processor, a memory storing a program for directing the processor, the processor operable with the program to: receive, at the POS terminal and via the RFID reader, a unique identifier (UID) comprising information corresponding to an article, wherein the UID was read by the RFID reader from at least one radio frequency identification (RFID) tag associated with the article; confirm an authenticity and availability for purchase of the article by comparing the UID with a list of authentic UIDs stored in an accessible database; change, only if the confirming is successful, a first state of the at least one RFID tag from a locked state to an unlocked state, thereby allowing a pairing of the RFID tag with a user account of a user attempting to purchase the article; and facilitate the pairing of the UID of the RFID tag with the user account.

In embodiments, the processor is operable with the program to facilitate the pairing comprises coordinating with a software application on a mobile device of the user.

In some embodiments, the processor is operable with the program comprises the processor being operable with the program to facilitate an updating of a second state of the at least one RFID tag from an unpaired state to a paired state.

In other embodiments, the processor is operable with the program comprises the processor being operable with the program to store, in the accessible database, an indication of the user account in association with the UID of the at least one RFID tag.

In embodiments, the processor is operable with the program comprises the processor being operable with the program to unpair the UID of the at least one RFID tag, as stored in the accessible database, from an account of a provider of the article and instead pair it with the user account.

In some embodiments, the processor is operable with the program comprises the processor being operable with the program to generate a confirmation code where the confirmation code indicates that the article is being purchased by the user from an authorized retailer and being for provision to the user to enter into a software application on the mobile device of the user.

In other embodiments, the processor is operable with the program comprises the processor being operable with the program to access a record of the accessible database to confirm that the UID is not currently paired with any user account.

In embodiments, the processor is further operable with the program to: verify, prior to the confirming, that the first state of the at least one RFID tag is in a locked state and only performing the confirming if the verifying is successful, otherwise outputting an error message to an operator of the at least one RFID reader.

In some embodiments, the processor is further operable with the program to: prevent a purchase of the article by the user if the confirming is not successful. In other embodiments, the processor is operable with the program to prevent the purchase by causing a transaction mode of the POS terminal to be disabled. In embodiments, the processor and program is a processor and program of the RFID reader. In other embodiments, the processor and program is a processor and program of the POS terminal.

In accordance with one illustrative embodiment, an RFID tag comprises a first binary and changeable state that can be set to either a locked status or an unlocked status and a second binary and changeable state that can be set to either a paired status or an unpaired status, wherein the second state cannot be changed from an unpaired status to a paired status unless the first state is set to the unlocked status.

In embodiments, the first state is only operable to be changed by a certified retailer of an article to which the RFID tag corresponds.

In some embodiments, the first state is only operable to be changed from a locked status to an unlocked status upon receiving a predetermined signal from a system of the certified retailer.

In accordance with one illustrative embodiment, a method for authenticating an article comprises obtaining an article having at least one radio frequency identification (RFID) tag associated therewith where the at least one RFID tag having a unique identifier (UID) comprising information representative of the article, reading the at least one RFID tag to obtain the UID, transitioning the at least one RFID tag from a locked condition to an unlocked condition, comparing the UID with a list of authentic UIDs stored in an accessible database to determine an authenticity of the article and transitioning the at least one RFID tag from an unpaired mode to a pairing mode to enable the RFID tag to be paired with a user account by an authenticity verification software product. The method is performed by one or more processors coupled to memory.

In embodiments, transitioning the RFID tag from a locked condition to an unlocked condition is performed by an RFID reader.

In some embodiments, reading the RFID tag is performed with the RFID reader.

In other embodiments, the method includes reading first and second RFID tags associated with the article to obtain first and second UIDS and comparing the first and second UIDs with the list of authentic UIDs stored in the accessible database to determine the authenticity of the article.

In embodiments, the first RFID is associated with the article and the second RFID is associated with packaging of the article.

In some embodiments, the article comprises one of alcohol goods, clothing, accessories, eyewear, jewelry, furniture, electronics or cosmetics.

In other embodiments, the method includes pairing, with the authenticity verification software product, the RFID tag of the article with the user account.

In embodiments, the article comprises one of alcohol goods, clothing, accessories, eyewear, jewelry, furniture, electronics or cosmetics.

In accordance with another illustrated embodiment, a method for authenticating an article comprises obtaining an article having at least one radio frequency identification (RFID) tag associated therewith with the at least one RFID tag having a unique identifier (UID) comprising information representative of the article, opening an authenticator application product with a user device, reading with the user device the at least one RFID tag to obtain the UID to enable the authenticator application product to compare the UID with a list of authentic UIDs stored in an accessible database to determine an authenticity of the article, confirming the authenticity of the product and pairing the RFID tag of the article with an account associated with the user. The method is performed by one or more processors coupled to memory.

In embodiments, the authenticator application product is stored on the user device and wherein opening the authenticator application product includes accessing the authenticator application product on the user device.

In some embodiments, the authenticator application product is stored on one or more remote databases and wherein opening the authenticator application product includes accessing the authenticator application product with the user device.

In other embodiments, the method includes transitioning, with the authenticator application product, the RFID tag from an unpaired condition to a pairing condition to enable pairing with the account of the user.

In embodiments, transitioning the RFID tag from the unpaired condition to the pairing condition is performed in association with reading, with the user device, the at least one RFID tag.

In some embodiments, the method further includes pairing the RFID tag of the article with a second account different from the first-mentioned account.

In other embodiments, the article comprises one of alcohol goods, clothing, accessories, eyewear, jewelry, furniture, electronics or cosmetics.

In accordance with another illustrative embodiment of the present invention, a computer program product, tangibly stored in a non-transitory computer-readable medium and comprising computer-executable instructions, wherein when executed, the computer-executable instructions cause a device to open an authenticator application product with a user device, read with an RFID reader of the user device a radio frequency identification (RFID) tag of an article to obtain a unique identifier (UID) of the RFID tag, the UID comprising information representative of the article, compare the UID with a list of authentic UIDs stored in an accessible database to determine an authenticity of the article and transition the RFID tag from an unpaired mode to a pairing mode to enable the RFID tag to be paired with a user account.

In embodiments, the computer-executable instructions further causes a device to transition the RFID tag from a locked condition to an unlocked condition.

In some embodiments, transitioning the RFID tag from the locked condition to the unlocked condition is performed in association with reading, with the RFID reader of the user device, the RFID tag of the article.

In other embodiments, transitioning the RFID tag from the locked condition to the unlocked condition is performed in association with reading, with a second RFID reader different from the RFID reader of the user device, the RFID tag of the article.

In embodiments, opening the authenticator application product includes accessing the authenticator application product stored on the user device.

In some embodiments, opening the authenticator application product includes accessing the authenticator application product stored on one or more remote host databases.

In other embodiments, the computer-executable instructions further causes a device to pair the RFID tag of the article with a second account different from the first-mentioned account.

In some embodiments, the computer-executable instructions further causes a device to read first and second RFID tags associated with the article to obtain first and second UIDS and compare the first and second UIDs with the list of authentic UIDs stored in the accessible database to determine the authenticity of the article.

In other embodiments, the article comprises one of alcohol goods, clothing, accessories, eyewear, jewelry, furniture, electronics or cosmetics.

In accordance with another illustrative embodiment of the present invention, a system for authenticating a product comprises an RFID tag coupled to a product with the RFID tag comprising a UID, a first updateable state and a second updateable state, wherein the first updateable state comprises one of a locked and unlocked state, and wherein the second state comprises one of a paired and unpaired state, a database storing the UID, a first RFID reader configured to change the first updateable state from the locked state to the unlocked state, a second RFID reader configured to read and store the UID of the RFID tag and pair the RFID tag with information stored within an application installed on a personal mobile device of a user, and a computing device configured to communicate with the database over a network and verify the existence of the UID of the RFID tag within the database, and to communicate with a user a result of the verification.

In embodiments, first RFID reader and the second RFID reader comprise the same RFID reader.

In accordance with another illustrative embodiment of the present invention, a method for authenticating a product comprises providing an RFID tag on a product, reading, on a first RFID reader, a UID and a first updateable state of the RFID tag, updating the first updateable state of the RFID tag from a locked state to an unlocked state, comparing, via network communication, the UID of the RFID tag with a list of authentic UIDs on a remote database, reading, on a second RFID reader, the UID of the RFID tag via an application stored on a mobile device of a user, and storing the UID of the RFID tag within memory of the application and communicating, via the network, the UID and at least one identifying information of the user.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a schematic of the authenticity verification system according to one or more illustrative embodiments of the present invention;

FIG. 2 is a view of a system including the authenticity verification product of the authenticity verification system according to one or more illustrative embodiments of the present invention;

FIG. 3 is a schematic figure of an RFID tag of the authenticity verification system according to one or more illustrative embodiments of the present invention; and

FIG. 4 is a flow diagram of a verification process of the authenticity verification system according to one or more illustrative embodiments of the present invention;

FIGS. 5 and 6 are flow charts illustrating methodologies of use of the of the authenticity verification system according to one or more illustrative embodiments of the present invention; and

FIG. 7 is a view of a computing environment for use with the authenticity verification system according to one or more illustrative embodiments of the present invention.

### DETAILED DESCRIPTION

### I. Introduction

Described herein are systems and processes for identifying the authenticity of products susceptible to theft and/or counterfeiting or helping users identify whether such a product is authentic, authorized, and/or from a credible source rather than counterfeit. Examples of products for which the systems and methods described herein are wide-ranging and essentially encompass any product that may be equipped with appropriate RFID technology (e.g., luxury products) . One exemplative application or use for at least some of the systems and methods described herein is a luxury item (e.g., a high-end bag or clothing item) that is equipped with appropriate RFID technology configured to confirm the authenticity of the item, to help alleviate a purchaser's (or potential purchaser's) concerns regarding whether the item is counterfeit prior to purchasing it. Applicant describes herein a novel and easy-to-discern or easy-to-test authenticity verification measure that may be utilized on various types of items to confirm that they are not counterfeit and thus prevent harm to the users and/or purchasers thereof.

In accordance with systems and method described herein, systems and methods which provide for identifying authentic products and tracking products such as luxury items (e.g., wine and other high-quality spirits, purses, shoes and other leather garments, perfumes, cosmetics and skincare items, watches, jewelry, eyewear, etc.) using a Radio Frequency Identification (RFID) device or tag implanted and/or otherwise permanently attached to the product. In accordance with some embodiments, systems, processes and articles of manufacture provide for associating a particular RFID-enabled chip with a particular owner of the product. In accordance with some embodiments, systems, processes and articles of manufacture provide for the recognition and/or tracking of proper ownership of the product. In accordance with some embodiments, a system is provided which includes an RFID tag having two changeable state switches; locked and unlocked, and paired and unpaired. In accordance with some embodiments, the system includes a security reader/writer that is able to change the two changeable state switches and a mobile application that allows for a user to read the RFID tag and associate the RFID tag (and by extension, ownership of the product) with the user or an account of the user.

Embodiments of the present disclosure provide a method, system and computer program product for enabling a user access to an application verification software product downloadable onto a user device or accessible through one or more links, software products, etc. via a user device such as a mobile electronic device, mobile phone, tablet, personal digital assistant, desktop computer, laptop computer etc. More specifically, illustrative embodiments of the present disclosure are directed to an apparatus and system including an application software product, for example, a downloadable mobile application product or web-accessible software product (also referred to as authenticity verification application) which enables access of a user to a database of a manufacture or distributor containing a listing of multiple UIDs of RFID tags. In embodiments, the authenticity verification application is at least in part downloaded on the user device or a link to the authenticity verification application may be presented on the user device as an icon, tab or the like.

### II. Examples of Systems for Verifying Authenticity of a Product

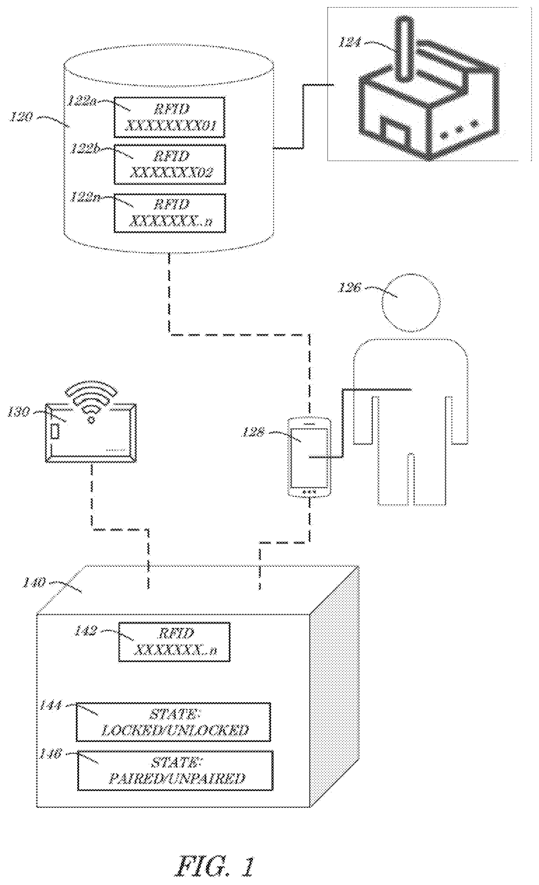

Referring first to FIG. 1, various embodiments disclosed herein relate to systems and methods of verifying the authenticity and ownership of a product. In some embodiments, an RFID tag 140 is applied to product (e.g., sown into the fabric, attached under an adhesive label of a container, such as a wine bottle, applied within a carrying case, and/or any other application method) and characteristics of the product (e.g., product type, stock keeping unit (SKU), and/or any other parameters associated with the product) is associated with a universal unique identification number (UID) 142 of the RFID tag. In such embodiments, the RFID tag 140 may be applied during the finishing stage of manufacture, although this may be impracticable with some products. In some embodiments, the RFID tag 140 may be adhered to the product in such a way that the RFID tag is broken if the RFID tag is removed (or is attempted to be removed) from the product. In some embodiments, the UID 142 of the RFID tag is designated at the RFID tag manufacturer and cannot be changed. In some embodiments, RFID tags 140 may be applied to disposable packaging (e.g., a wrapping box or packet) of the product, and/or to a shipping unit (e.g., a pallet) containing a number of products in order to verify the authenticity and/or track products in bulk. In other embodiments, multiple RFID tags may be applied to the article and packaging associated with the article.

In some embodiments, the RFID tag 140 may include first and second changeable states 144, 146. In some embodiments, the changeable states 144, 146 may include locked and unlocked, and paired and unpaired (e.g., whether the RFID tag is associated with an account of a user 126). In such embodiments, when the RFID tag 140 is in the locked state, the RFID tag is unable to be paired (and by extension, associated with the account of a user 126), and when the RFID tag is in the unlocked state, the RFID tag is able to be paired (and by extension, associated with an account of a user 126). In some embodiments, the RFID tag 140 may ship from the product manufacturer 124 to the retail outlet in a locked and unpaired state (i.e., the RFID tag is not currently and is unable to be associated with an account of a user). In some embodiments, the retail outlet may include a reader 130 that is able to change at least the locked/unlocked changeable state of the RFID tag to an unlocked state. In some embodiments, the retail outlet may unlock the RFID tag of the product after the transaction (e.g., the purchase of the product) is complete.

In some embodiments, when the RFID tag 140 is in the unlocked state, a user (e.g., the purchaser of the product) may open an application on the user's mobile device 128 (the application may be downloaded to the user's device before entering the retail outlet or while at the retail outlet using the device's or the user's app store of choice) which uses the mobile device's 128 onboard hardware to read the RFID tag 140 and pair it with information about the user stored within the application (e.g., by physically touching the RFID tag 140 with the mobile device 128 and/or by activating the reader onboard the mobile device 128 through the application). In some embodiments, the results of the association of the user information and the RFID tag 140 may be communicated with and recorded on a computing device having a database 120 at the product manufacturer 124 and/or the RFID tag manufacturer. In some embodiments, the UID 142 of the RFID tag 140 is confirmed as authentic and available for pairing at the product manufacturer and/or the RFID tag manufacturer and information relating to the authenticity and availability of the UID 142 may be communicated to the user 126 through the mobile device 128 (e.g., through the mobile application, via text or SMS message, via a voice message, and/or any other communication). In some embodiments, the confirmation of the RFID tag's authenticity and availability is completed before the user completes the purchase of the product (or the use of the product, in accordance with some embodiments).

### III. Examples of Packaging Systems for Verifying Authenticity of a Product

In some embodiments, the product RFID Tag is applied to the product during finishing phases. In some embodiments including leather goods, it may be sown into or onto the fabric, or into a compartment of the product. In some embodiments, for some types of products such as wine or perfume, it may be under an adhesive label. In some embodiments, for products that are sold with carrying cases, such as watches, eyewear, and jewelry, the RFID tag may be applied on the carrying case in lieu of, or in addition, to the item or good. In some embodiments, the RFID tag may be read by an RFID reader, and the UID associated with that RFID tag is tied to that product's brand name, model number, unique unit identifier, batch number or other characteristic, in a database of a computing device at the product manufacturer and/or the RFID tag manufacturer.

In some embodiments, the product is then packaged in an outer wrap or box (i.e., product packaging). In some embodiments, a product packaging RFID tag may then be applied to the product packaging. According to some embodiments, the product RFID tag and the product packaging RFID tag may be read simultaneously by an RFID reader in accordance with embodiments described herein, and the respective UIDs of each of the product RFID tag and the product packaging RFID tag may be coupled in the database.

In some embodiments, the product may then be put with other like products on a shipping unit (e.g., a pallet or other bulk packaging unit). A shipping unit RFID tag may then be attached to the shipping unit. In some embodiments, all RFID tags (e.g., product RFID tags and product packaging RFID tags) in the shipping unit are read together and coupled to the shipping unit RFID tag in the database.

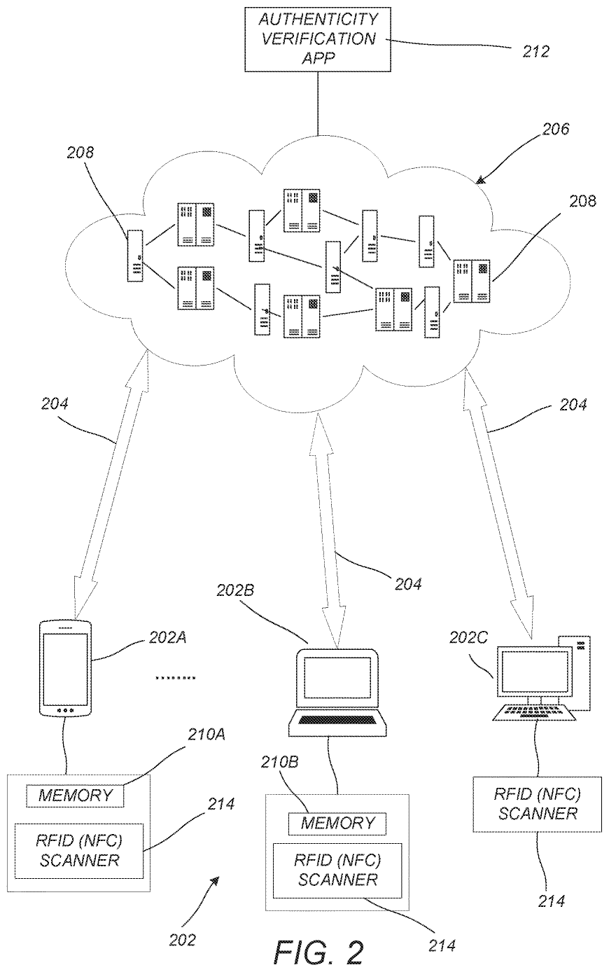

FIG. 2 is a block diagram of a system 200 including the authenticity verification application according to illustrative embodiments of the present disclosure is shown. In some embodiments, the system 200 may be used by a plurality of user devices 202, independently operated and/or owned (only three being shown for clarity), a network 204 and a centralized computing environment 206 such as a cloud computing environment having one or more computing nodes 208. The user devices 202 each can access the authenticity verification application through the network 206.

The user device, in some embodiments, may comprise any types or configurations of computing, mobile electronic, network, user, and/or communication devices that are or become known or practicable. In some embodiments, a first user device 202A may comprise a mobile electronic device such as a smartphone or tablet housing a local or memory device 210-A. For example, the user device 202A may and/or cellular and/or wireless telephones or “smart” phones, such as an iPhone® (also manufactured by Apple®, Inc.) or an Optimus™ L90™ smart phone manufactured by LG® Electronics, Inc. of San Diego, Calif., and running the Android® operating system from Google®, Inc. of Mountain View, Calif., or a Galaxy® Note20™ 5G (manufactured by Samsung® Electronics Co., Ltd. of Suwon, South Korea). In other embodiments, the user device 202A may include a tablet computer, such as an iPad® manufactured by Apple®, Inc. of Cupertino, Calif., programming workstations, such as the Titan® C200™ compact AMD® RYZEN® 9 Workstation PC (manufactured by Titan® Computers of Hallandale Beach, Fla. In some embodiments, a second user device 202B may comprise a desktop housing a memory device 210B. In some embodiments, the user device 202 may comprise one or more devices owned and/or operated by one or more users, such as a remote worker, employee, etc. According to some embodiments, the user device may store and/or execute specially programmed instructions to operate in accordance with embodiments described herein. The user device 202 may, for example, execute one or more mobile device programs that activate and/or control the user device 202, identify one or more rules associated with the applications, evaluate the one or more rules, and/or provide output. According to some embodiments, the user device 202 may communicate with the computing environment 206 via the network 204 to invoke and/or utilize the authenticity verification application 212 which is accessed and/or downloaded onto the, for example, user device 202 via the one or more computing nodes 208 of the computing environment 206. In some embodiments, the user device 202B may be a virtual machine. In other embodiments, the user device 202C may be a desktop or laptop computer.

Each user device 202 includes an RFID scanner 214 to scan the RFID tags associated with the article. In some embodiments, each user device 202 may include or have access to Near Field Communication (NFC) technology which is RFID compatible to enable scanning of RFID tags. The user device 202 in the form of a smartphone may include, for example, a built in NFC scanner 214 or may be capable of downloading an application product providing NFC scanning capabilities. In some embodiments, the user device 202 may have, or be associated with, a separate RFID scanner 214 which is in communication with the host computer user device 202c through wired connections such as USB, RS232 (serial), or Ethernet or wireless connections such as Wi-Fi, Bluetooth, or Zigbee.

The network 204 may, according to some embodiments, comprise a Local Area Network (LAN; wireless and/or wired), cellular telephone, Bluetooth® and/or Bluetooth® Low Energy (BLE), Near Field Communication (NFC), and/or Radio Frequency (RF) network with communication links between the user device 202 and the computing environment 206. In some embodiments, the network 204 may comprise direct communications links between any or all of the components interconnected via one or more wires, cables, wireless links, and/or other network components, such network components (e.g., communication links) comprising portions of the network 204. In some embodiments, the network 204 may comprise one or many other links or network components other than those depicted in FIG. 2. The user device 202 may, for example, be connected to the computing environment 206 via various cell towers, routers, repeaters, ports, switches, and/or other network components that comprise the Internet and/or a cellular telephone (and/or Public Switched Telephone Network (PSTN)) network, and which comprise portions of the network 204.

While the network 204 is depicted in FIG. 2 as a single link or line, the network 204 may comprise any number, type, and/or configuration of networks that is or becomes known or practicable. According to some embodiments, the network 204 may comprise a conglomeration of different sub-networks and/or network components interconnected, directly or indirectly, by the components of the system 200. The network 204 may comprise one or more cellular telephone networks with communication links between the user device 202 and the computing environment 206.

In some embodiments, the computing environment 206 includes one or more cloud computing nodes 208 with which local computing devices used by cloud consumers, such as, for example, personal digital assistant (PDA) or a cellular telephone, a desktop computer, a laptop computer, and/or automobile computer system may communicate. The computing nodes 208 may communicate with one another. They may be grouped (not shown) physically or virtually, in one or more networks, such as Private, Community, Public, or Hybrid clouds as described hereinabove, or a combination thereof. This allows cloud computing environment to offer infrastructure, platforms and/or software as services for which a cloud consumer does not need to maintain resources on a local computing device. It is understood that the types of computing devices are intended to be illustrative only and that computing nodes 108 and cloud computing environment 106 can communicate with any type of computerized device over any type of network and/or network addressable connection (e.g., using a web browser).

One or more of the computing devices of the computing environment may access or store the authenticity verification application product 212 to execute the application in accordance with the methodology described hereinbelow. In some embodiments the features of the authenticity verification application product 212 may be embodied as an “APP” that is downloadable onto a user device 202 such as a smartphone, tablet, etc. (ANDROID, IPHONE or IPAD). In other embodiments, the authenticity verification application product 212 may be accessible via a web address. In other embodiments, the authenticity verification application product 212 may be stored on any storage medium and accessible through a link or the like to the user device 202.

### IV. Examples of RFID Tags for Use with Some Embodiments

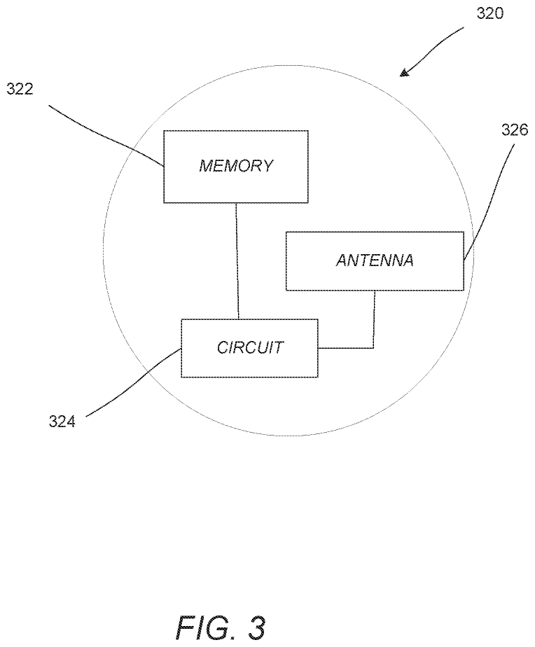

An embodiment of an RFID-enabled chip that may be useful in some embodiments described herein is illustrated in FIG. 3. The example chip 320 includes a radio frequency identification (RFID) tag or memory 322 with an electronic circuit or processor 324 and an antenna 326. The chip 320 may be similar or identical to those disclosed in U.S. Pat. Nos. 5,166,502; 5,676,376; 6,021,949; and 6,296,190, and U.S. Patent Application Publication Nos. 2004/0207156 and 2004/0219982, the contents of which are all incorporated by reference in their entireties. Sato Vicinity Pty Ltd, also manufactures RFID tags, such as that described in U.S. Pat. No. 9,165,171 to Murdoch et al., which may be suitable for use in some embodiments described herein and which patent is incorporated by reference herein. Gaming Partners International (GPI), of 1182 Industrial Road, Las Vegas, Nevada 89102 and Abbiati Casino Systems of Strada della Risera, 9-10090 Rosta (Torino-Italia) both sell RFID tags suitable for use in accordance with embodiments described herein, although neither product is specifically required to practice the concepts of the present disclosure. The GPI chip uses a standard microchip made by Philips Semiconductors called the Vegas S, each of which has a unique serial number. The product manufacturer or other entity may associate values with each serial number. The association may be in a look-up table or the like. Alternatively, the UID may be encoded to include information therein.

In use, the electronic circuit 324 and antenna 326 act as a transponder capable of responding to an interrogator of the retail outlet and/or the mobile device of the user (not separately shown in FIG. 3). The interrogator may be a sensor or other component operable to detect, recognize, determine, identify or sense the presence (or absence) of an RFID-enabled chip. The interrogator may also be operable to detect, determine, identify, recognize or receive various information about a product (e.g., product type, SKU, etc.). The interrogator may also be operable to transmit information to one or more processors or memories (e.g., information regarding the presence or absence of a chip in a certain location, an identifier of a product, etc.). In some embodiments, an interrogator may operate in accordance with passive RFID technology and/or comprise an antenna such as a Near Field Communication (NFC) and/or Phase Jitter Modulation (PJM) readers (collectively, “RFID readers”).

In accordance with some embodiments, the interrogator sends out an electromagnetic signal that impinges upon the antenna 326, exciting a current within electronic circuit 324. In response to the excited current, the electronic circuit 324 causes the antenna 326 to emit a second electromagnetic signal as a response, which is received by the interrogator. The second signal has identifying information about the chip 320 encoded therein such that the interrogator can identify the chip on receipt of the second signal. The second signal may be generated passively or actively. That is, in some embodiments, the energy from the interrogation signal provides sufficient power for the electronic circuit 324 to use to send the second signal. In other embodiments, the electronic circuit 324 may include a battery or other power source, which is used to power the generation of the second signal. While batteries have increasingly small footprints and longer lives, it is generally more practical to have a passive transponder.

### V. Examples of Authenticity Verification Check Process

In some embodiments in which the product is a luxury item (e.g., a user including a transportation/distribution agent, a retail agent and/or an end user) may access one or more articles requiring verification. The user may place the article having an RFID tag near an RFID reader coupled to a computing device having a readable screen (e.g., a desktop computer, a laptop computer, a mobile device, etc.) on-site with the user. In some embodiments, the RFID reader may sense the UID of the RFID tag that is being used on-site. In some embodiments, the computing device may then communicate with a database of the authentic manufacturer to ensure that the UID of the RFID tag on the one or more articles matches an authentic and/or unused UID on a database associated with the article. In some embodiments, the user may obtain/purchase the article if so confirmed. In some embodiments, the user may disregard or not purchase the article in the event that verification is not confirmed. In some embodiments, the user may call or otherwise communicate with the authentic manufacturer to report irregularities and/or ensure database and RFID tag integrity.

In some embodiments the product may be a retail item (e.g., a luxury item) that is purchased in a retail store. In such embodiments, the customer who is purchasing the item may be the user who engages in the example process described herein at a check-out area or cash register of the retail establishment.

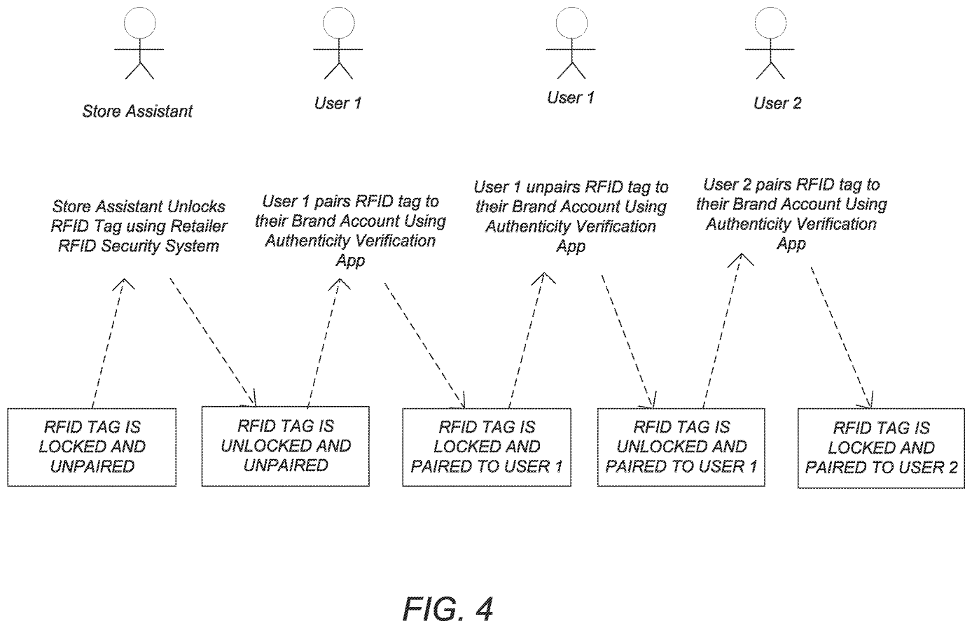

FIG. 4 illustrates an example process that the consumer at a retail outlet or other distribution node for an article or product (e.g., a retail store or other seller of luxury items, or a pharmacy or clinic for pharmaceutical products) may engage in to verify the authenticity of a product they are obtaining. In some embodiments, a user takes the product to the checkout register. In embodiments, the RFID tag associated with the article is in a locked state and an unpaired state. In the locked state, the RFID tag may not be capable of being read by an RFID scanner or, in embodiments, by an unauthorized RFID scanner. During the checkout process, the retail worker places the product on or near an RFID reader. The RFID tag is unlocked by, for example, an authorized RFID scanner associated with the manufacture of the article or the retail agent. The RFID reader scans the product RFID tag and/or the product packaging having the RFID tag. The RFID reader communicates with a manufacturer database via a network and cross-references the UID of the RFID tag with the database to confirm that both RFID tags are valid and authentic, and that they should be associated together. In some embodiments, the RFID reader may also have a screen that shows the product that UID is associated with, for additional verification by the user. If any of the above security checks come back negative, the user may be notified by an appropriate indication or message being output. The user may still go through with the transaction if desired, but would do so knowing that the authenticity verification had failed. In some embodiments, the user may file a discrepancy report and/or send a note to the manufacturer to resolve any issue with RFID tags or the products associated with the database (e.g., either immediately or sometime after the transaction or attempted transaction). In accordance with some embodiments, in the event that the RFID-based authenticity security check is completed successfully, the user can continue with relevant conventional steps of completing the transaction. In some embodiments, the financial aspects of the transaction may be completely separate from the authenticity security check (e.g., utilizing separate software and/or hardware, processes, workflows, etc.).

In accordance with some embodiments, during an authenticity security check process, the user or user device may transmit an instruction or signal to the manufacturer, through the RFID reader, to turn on “pairing mode” for the product's RFID tag. In some embodiments, once in pairing mode, the user may open the authenticity verification application product on a smartphone or other user device described hereinabove, and touches the smartphone or other appropriately equipped user device (e.g., a dedicated user device programmed to perform functionality as described herein and storing the authenticity verification application product as described herein) to the RFID tag on the product. Responsive to this, the authenticity verification application product may be operable to recognize and/or confirm the UID and ask the user if they want to pair that UID with their account. If the customer confirms, the UID may be paired with the customer's account and thereafter the pairing mode for that RFID tag may be disabled. In accordance with some embodiments, either a merchant or other provider of the product (using their RFID reader) or the user with whom the UID is paired with (using their mobile app) can turn pairing mode back on for that RFID tag, allowing a new account (e.g., a second user or consumer) to pair with the RFID tag. In some embodiments, only one account can be paired with a UID at any given time. In some embodiments, even if a merchant or other type of product provider may not be paired to the UID, they may be authorized with a master ability to pair and unpair UIDs.

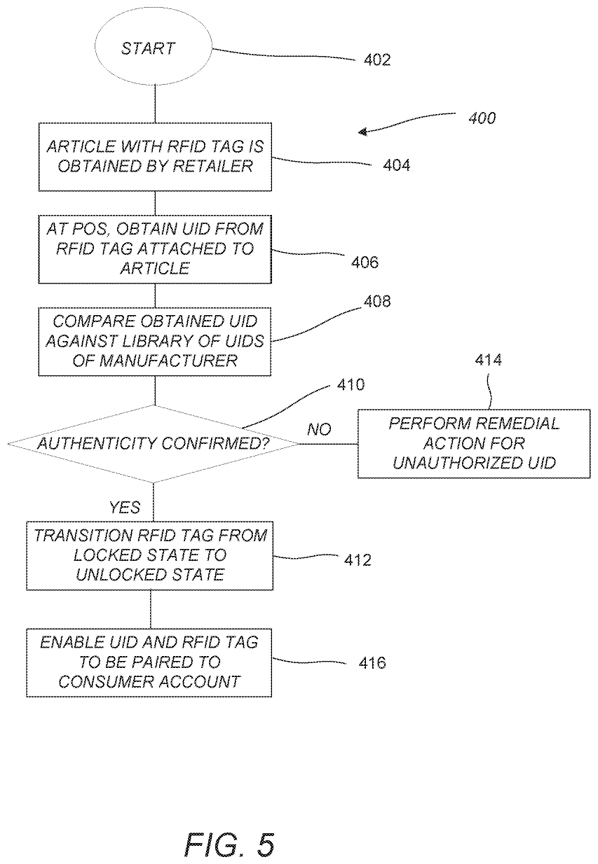

Referring now to FIG. 5, there is illustrated a flow chart 400 depicting features of the system, methodology and product of the present disclosure. The processes identified in the flow chart 400 may be retailed to applications in which the end retailer/merchant and/or intermediate transporter scans received articles to prepare the article(s) for purchase by a consumer. The process is started (STEP 402) with one or more RFID tags being associated with an article. For example, in embodiments, a unique identifier (UID) is embedded or stored in the memory of an RFID tag. RFID tags generally include one of the following memory types: 1) read only in which the UID is programmed during manufacturing and cannot be changed (ensuring the UID is permanent and tamper-proof); 2) Write-Once-Read-Many (WORM) in which the (UID) can be written once after production, then becomes permanent; and 3) Read-Write (RW) in which the UID and other data can be rewritten multiple times, offering flexibility. The UID is stored in one or more databases containing a listing of RFID tags and associated UIDS. The listing of databases is obtained and recorded in one or more databases storing a listing of UIDS of RFID tags assigned to respective articles made available by the manufacturer/distributor. In one exemplative application, the STRP-5050 Tunnel Reader made available by Sato Holding may be used. This Tunnel Reader is capable of writing product codes (UIDs) on RFID tags at the rate of fifty (5) tags per second. The one or more articles may be shipped to one or more intermediate distribution facilities prior to reception by a retailer. In embodiments, the one or more articles are shipped with the RFID tags in a locked and unpaired condition. In certain embodiments, the RFID tag may include circuitry or logic which maintains the RFID tag in a locked condition.

In STEP 404, the article with the RFID tag in a locked condition is obtained/received by the merchant and may be presented for sale either in a physical store or online. Once a consumer/customer decides to purchase the article, the article is presented to the retailer for checkout associated with the sale of the article. In embodiments, the article is taken to a point-of-sale (POS) terminal of the retailer having a stationary or portable RFID reader/scanner under the control of the retailer. With the RFID scanner at the terminal, the UID of the RFID tag is read/obtained by the RFID scanner. (STEP 406). In STEP 408, the UID is compared with a list of authentic UIDS stored in a database of the manufacturer/provider of the article to determine the authenticity of the article by the retailer. In STEP 410, authenticity of the article is determined via the RFID scanner and one or more processors associated with the database hosting the list of UIDS. In the event authenticity is confirmed (“YES” in the flow chart), the retailer may transition the RFID tag from a locked state to an unlocked state via the one or more processors and associated logic of the system. (STEP 412) In some embodiments, the transition to the unlocked state occurs instantaneously upon proper verification or confirmation of the UID of the RFID tag. In other embodiment, the system may send a signal to the RFID scanner or software associated with the retailer indicating proper confirmation at which occurrence the retailer may take affirmative action to unlock the RFID tag via the RFID scanner under the control of the retailer. In the event authenticity of the UID is not confirmed (“NO” in the flow chart), the retailer may perform one or more remedial actions including without limitation contacting representatives of the manufacture to determine the cause of the failed authenticity, outputting an error message by the processor causing a transaction mode of the RFID scanner and associated system to be disabled, and/or otherwise preventing the transaction from occurring (STEP 414). In some embodiments, the consumer may decide to effect the purchase even in the event there is no confirmation of authenticity of the UID of the article.

In STEP 416, once in the unlocked state of the RFID tag, the RFID tag is placed or transitioned from an unpaired state or mode to a pairing state or mode. In some embodiments, this occurs simultaneously with unlocking of the RFID tag. In other embodiments, a further affirmative action may be required to change the RFID tag to the pairing mode, for example, in response to a single or notification sent from the system associated with the manufacturer. In the pairing mode, the UID and RFID tag may be paired or linked with an account of the consumer.

In illustrative embodiments, STEPs 412 and 416 may occur simultaneously via a single scan implemented by the RFID scanner under the control of the retailer in the event authenticity is confirmed.

In some embodiments, multiple RFID tags may be associated with the article. For example, an RFID tag (a first RFID tag) may be attached or embedded in the article and a second RFID tag may be attached to the packaging of the article. The multiple RFIDs each include a unique UID which is cross-referenced in the listing of UIDS linking the article with the two RFIDS. Multiple RFIDs may provide an extra level of authenticity of the article. In embodiments with multiple RFID tags associated with the article, STEP 406 may include obtaining multiple UIDs off the RFID tags associated with the article and STEP 408 may include comparing the multiple UIDs associated with the article to the database listing. For example, in embodiments, the first and second UIDs are read by the RFID scanner and compared with the list of authentic UIDs stored in the accessible database.

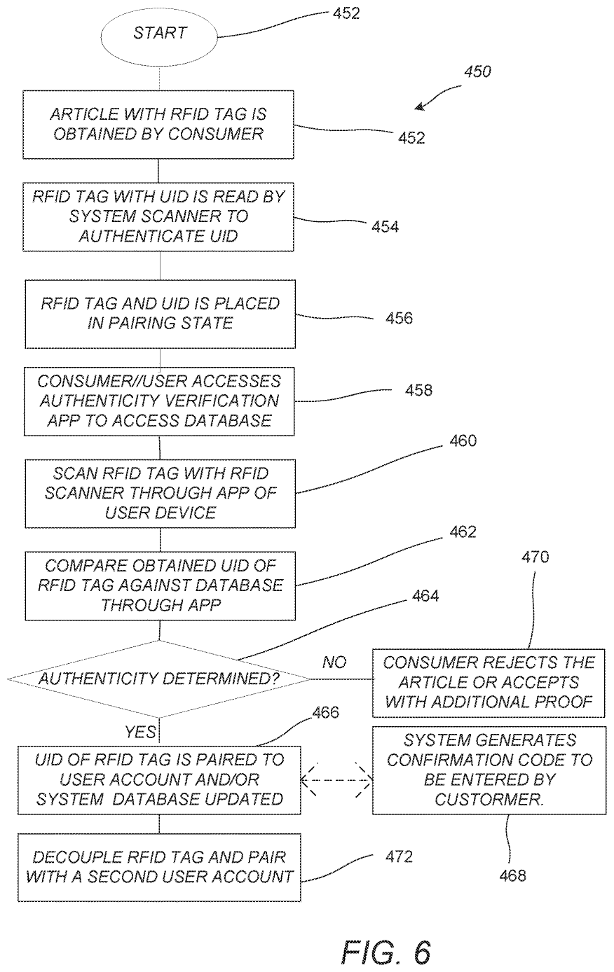

Referring now to FIG. 6, there is illustrated a flow chart 450 depicting additional features of the system, methodology and product of the present disclosure. The processes identified in the flow chart 450 may be retailed to applications in which the consumer confirms authenticity of the article with the authenticity verification application product, and links the article to an account associated with the consumer. The process is started with the consumer actively shopping for an article. (STEP 452). An article is selected by the consumer. The article includes an RFID tag having an UID as described hereinabove.

The RFID tag is read with an RFID scanner or security system associated with the retailer or the manufacturer to verify the authenticity of the RFID tag, or in the case of multiples tags, verify the authenticities of the multiple tags as described in connection with STEPS 406-410 of FIG. 5. That is, the UIDs of the RFID tags are obtained and compared against a database listing of authorized RFID tags (listed in a manufacturer/distributor listing) to verify the authenticity of the UID(s). (STEP 454). Thereafter, or concurrently therewith, the RFID tag is placed in the pairing state by the RFID scanner associated with the manufacturer or retailer. (STEP 456). In some embodiments, the RFID tag is transitioned from a locked state to an unlocked state by the processor of the system before, during or after transitioning of the RFID tag to the pairing state. The pairing state and/or unlocked state of the RFID tag may be updated in the memory of the database associated with the system.

The process is continued by the user/consumer accessing the authenticity verification application product (“APP”) with the user device. (STEP 458). In some embodiments, the authenticity verification application is already downloaded onto the smart device of the consumer such as a smartphone or the like. In illustrative embodiments, the authenticator application product may be available on the WEB through a web site or through conventional APP stores including, without limitation, Apple and Google apps. The verification application may be downloaded onto the user device or accessed through a web address by the user device. As noted hereinabove, the user device may include a mobile phone, such as an IPHONE or ANDROID, that performs many of the functions of a computer, typically having a touchscreen interface or other input component, e.g. a scanner, internet access, imaging/scanning capabilities and an operating system capable of running downloaded applications. In other embodiments, the authenticity verification application is accessed by a desktop or laptop computer through one or more networks disposed on a remote database. The authenticity verification application product once opened may enable access to the listing of UIDS on the database of the manufacturer/distributor.

With the authenticity verification application product accessed and opened in the user device (e.g., smartphone, tablet, desktop and/or laptop), the RFID scanner associated with the user device is used to scan the RFID tag of the article via the authenticity verification application product to obtain the UID. (STEP 460). The obtained UID associated with the RFID tag of the article is compared against database of the manufacturer/distributor through the authenticity verification application product. (STEP 462). In STEP 464, authenticity of the UID of the RFID tag of the article is determined through the authenticity verification application product which is in communication with the database. In the event authenticity is confirmed (“YES” in the flow chart), the consumer may be paired with an account of the consumer through the authenticity verification application. (STEP 466). For example, in illustrative embodiments, the authenticity verification application will provide a pairing feature to enable pairing of the RFID tag with the consumer's account through action of the display of the user device. In other embodiments, once authenticity is determined the authenticity verification application will automatically effect the pairing. Pairing of the RFID tag with the user's account will provide additional security features to the RFID tag and the article to which it is attached. In addition, the database associated with the system may also be updated to reflect that the UID and RFID tag is associated with the specific account of the user/consumer. For example, once paired, the user is identified as the rightful owner of the article, and the database may be updated to reflect the RFID tag is changed from the retailer account to the consumer account. In embodiments, STEP 466 may also involve checking by the processor whether the UID of the RFID tag is already associated with another different customer account. In other embodiments, the system may generate a confirmation code requiring entry via the authenticity verification application on the user device or smartphone to effect the pairing. (STEP 468). In the event authenticity of the UID is not confirmed, the consumer may reject the article as not being authentic. In other embodiments, the consumer may accept the article if the retailer provides additional support that the article is authentic through, for example, contacting the manufacturer/distributor. (STEP 470).

In illustrative embodiments, the RFID tag may be decoupled by the user and then paired to a second user account different from the first account. This may occur in connection with gifting or resale of the article to a second user. (STEP 472). In certain embodiments, the authenticity verification application product can provide the coupling/decoupling capabilities. In other embodiments, the system of the retailer may also or alternatively provide the coupling/decoupling capabilities. In some embodiments, the new or second user account is updated via the authenticity verification application product (“APP”) or may be effected by the RFID scanner of the retailer.

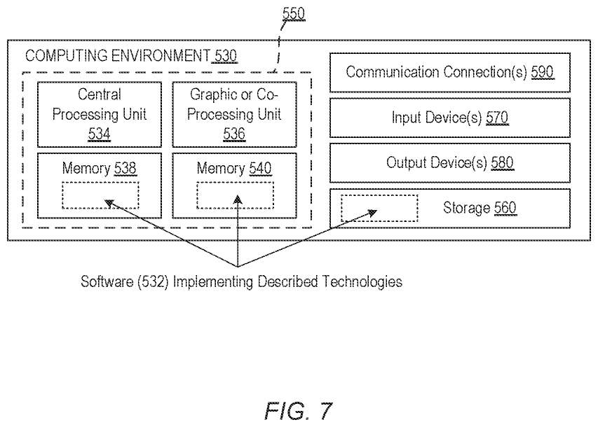

FIG. 7 depicts a generalized example of a suitable computing environment 530 in which the described innovations may be implemented. The computing environment 530 is not intended to suggest any limitation as to scope of use or functionality, as innovations may be implemented in diverse general-purpose or special-purpose computing systems. For example, computing environment 530 can be any of a variety of computing devices (e.g., a smartphone, a tablet, a desktop computer, laptop computer, server computer, tablet computer, etc.).

In the illustrated example, the computing environment 530 includes one or more processing units 534, 536 and one or more memories 538, 540, with this base configuration 350 included within a dashed line. The processing units 534, 536 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 5 shows a central processing unit 534 as well as a graphics processing unit or co-processing unit 536. The tangible memory 538, 540 may be volatile memory (e.g., registers, cache, RAM), non-volatile memory (e.g., ROM, EEPROM, flash memory, etc.), or some combination of the two, accessible by the processing unit(s). The memory 538, 540 stores software 532 implementing one or more innovations described herein, in the form of computer-executable instructions suitable for execution by the processing unit(s).

A computing system may have additional features. For example, the computing environment 530 includes one or more storage 560, one or more input devices 570, one or more output devices 580, and one or more communication connections 590. An interconnection mechanism (not shown) such as a bus, controller, or network interconnects the components of the computing environment 530. In some embodiments, an operating system software (not shown) can provide an operating environment for other software executing in the computing environment 530 and can coordinate activities of the components of the computing environment 530.

The tangible storage 560 may be removable or non-removable, and includes magnetic disks, magnetic tapes or cassettes, CD-ROMs, DVDs, or any other medium which can be used to store information in a non-transitory way, and which can be accessed within the computing environment 530. The storage 560 can store instructions for the software 532 implementing one or more innovations described herein.

The input device(s) 570 may be a touch input device such as a keyboard, mouse, pen, or trackball, a voice input device, a scanning device, or another device that provides input to the computing environment 330. The output device(s) 570 may be a display, printer, speaker, CD-writer, or another device that provides output from computing environment 530.

The communication connection(s) 590 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Python, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### VI. Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A system for authenticating an article, comprising:
at least one RFID reader;
a point-of-sale (POS) terminal communicatively coupled to the RFID reader;
at least one processor;
a memory storing a program for directing the processor, the processor operable with the program to:
receive, at the POS terminal and via the RFID reader, a unique identifier (UID) comprising information corresponding to an article, wherein the UID was read by the RFID reader from at least one radio frequency identification (RFID) tag associated with the article;
confirming an authenticity and availability for purchase of the article by comparing the UID with a list of authentic UIDs stored in an accessible database;
changing, only if the confirming is successful, a first state of the at least one RFID tag from a locked state to an unlocked state, thereby allowing a pairing of the RFID tag with a user account of a user attempting to purchase the article; and
facilitating the pairing of the UID of the RFID tag with the user account.

Clause 2. The system according to clause 1, wherein the processor being operable with the program to facilitate the pairing comprises coordinating with a software application on a mobile device of the user.

Clause 3. The system according to clause 1, wherein the processor being operable with the program to facilitate the pairing comprises the processor being operable with the program to facilitate an updating of a second state of the at least one RFID tag from an unpaired state to a paired state.

Clause 4. The system according to clause 1, wherein the processor being operable with the program to facilitate the pairing comprises the processor being operable with the program to store, in the accessible database, an indication of the user account in association with the UID of the at least one RFID tag.

Clause 5. The system according to clause 1, wherein the processor being operable with the program to facilitate the pairing comprises the processor being operable with the program to unpair the UID of the at least one RFID tag, as stored in the accessible database, from an account of a provider of the article and instead pair it with the user account.

Clause 6. The system according to clause 1, wherein the processor being operable with the program to facilitate the pairing comprises the processor being operable with the program to generate a confirmation code, the confirmation code indicating that the article is being purchased by the user from an authorized retailer and being for provision to the user to enter into a software application on the mobile device of the user.

Clause 7. The system according to clause 1, wherein the processor being operable with the program to confirm comprises the processor being operable with the program to access a record of the accessible database to confirm that the UID is not currently paired with any user account.

Clause 8. The system according to clause 1, wherein the processor is further operable with the program to:
verify, prior to the confirming, that the first state of the at least one RFID tag is in a locked state and only performing the confirming if the verifying is successful, otherwise outputting an error message to an operator of the at least one RFID reader.

Clause 9. The system according to clause 1, wherein the processor is further operable with the program to:
prevent a purchase of the article by the user if the confirming is not successful.

Clause 10. The system according to clause 1, wherein the processor being operable with the program to prevent the purchase comprises the processor causing a transaction mode of the POS terminal to be disabled.

Claim 11. The system according to clause 1, wherein the processor and program is a processor and program of the RFID reader.

Claim 12. The system according to clause 1, wherein the processor and program is a processor and program of the POS terminal.

Clause 13. An RFID tag comprises:
a first binary and changeable state that can be set to either a locked status or an unlocked status; and
a second binary and changeable state that can be set to either a paired status or an unpaired status,
wherein the second state cannot be changed from an unpaired status to a paired status unless the first state is set to the unlocked status.

Clause 14. The RFID tag according to clause 13, wherein the first state is only operable to be changed by a certified retailer of an article to which the RFID tag corresponds.

Clause 15. The RFID tag according to claim 14, wherein the first state is only operable to be changed from a locked status to an unlocked status upon receiving a predetermined signal from a system of the certified retailer.

Clause 16. A method for authenticating an article, comprising:
obtaining an article having at least one radio frequency identification (RFID) tag associated therewith, the at least one RFID tag having a unique identifier (UID) comprising information representative of the article;
reading the at least one RFID tag to obtain the UID;
transitioning the at least one RFID tag from a locked condition to an unlocked condition;
comparing the UID with a list of authentic UIDs stored in an accessible database to determine an authenticity of the article; and
transitioning the at least one RFID tag from an unpaired mode to a pairing mode to enable the RFID tag to be paired with a user account by an authenticity verification software product;
where the method is performed by one or more processors coupled to memory.

Clause 17. The method according to clause 16 wherein reading the RFID tag is performed with an RFID reader.

Clause 18. The method according to clause 16 wherein transitioning the RFID tag from a locked condition to an unlocked condition is performed by an RFID reader

Clause 19. The method according to clause 16 further including:
reading first and second RFID tags associated with the article to obtain first and second UIDS; and
comparing the first and second UIDs with the list of authentic UIDs stored in the accessible database to determine the authenticity of the article.

Clause 20. The method according to clause 19 wherein the first RFID is associated with the article and the second RFID is associated with packaging of the article.

Clause 21. The method according to clause 16 wherein the article comprises one of alcohol goods, clothing, accessories, eyewear, jewelry, furniture, electronics or cosmetics.

Clause 22. The method according to clause 16 including pairing, with the authenticity verification software product the RFID tag of the article with the user account.

Clause 23. The method according to clause 16 wherein the article comprises one of alcohol goods, clothing, accessories, eyewear, jewelry, furniture, electronics or cosmetics.

Clause 24. A method for authenticating an article, comprising:
obtaining an article having at least one radio frequency identification (RFID) tag associated therewith, the at least one RFID tag having a unique identifier (UID) comprising information representative of the article;
opening an authenticator application product with a user device;
reading with the user device the at least one RFID tag to obtain the UID to enable the authenticator application product to compare the UID with a list of authentic UIDs stored in an accessible database to determine an authenticity of the article;
confirming the authenticity of the product; and
pairing the RFID tag of the article with an account associated with the user;
where the method is performed by one or more processors coupled to memory.

Clause 25. The method according to clause 24 wherein the authenticator application product is stored on the user device and wherein opening the authenticator application product includes accessing the authenticator application product on the user device.

Clause 26. The method according to clause 24 wherein the authenticator application product is stored on one or more remote databases and wherein opening the authenticator application product includes accessing the authenticator application product with the user device.

Clause 27. The method according to clause 24 including transitioning, with the authenticator application product, the RFID tag from an unpaired condition to a pairing condition to enable pairing with the account of the user.

Clause 28. The method according to clause 27 wherein transitioning the RFID tag from the unpaired condition to the pairing condition is performed in association with reading, with the user device, the at least one RFID tag.

Clause 29. The method according to clause 24 further including pairing the RFID tag of the article with a second account different from the first-mentioned account.

Clause 30. The method according to clause 24 wherein the article comprises one of alcohol goods, clothing, accessories, eyewear, jewelry, furniture, electronics or cosmetics.

Clause 31. A computer program product, tangibly stored in a non-transitory computer-readable medium and comprising computer-executable instructions, wherein when executed, the computer-executable instructions cause a device to:
open an authenticator application product with a user device;
read with an RFID reader of the user device a radio frequency identification (RFID) tag of an article to obtain a unique identifier (UID) of the RFID tag, the UID comprising information representative of the article;
compare the UID with a list of authentic UIDs stored in an accessible database to determine an authenticity of the article; and
transition the RFID tag from an unpaired mode to a pairing mode to enable the RFID tag to be paired with a user account.

Clause 32. The computer program product according to clause 31 wherein the computer-executable instructions further causes a device to:
transition the RFID tag from a locked condition to an unlocked condition.

Clause 33. The computer program product according to clause 32 wherein transitioning the RFID tag from the locked condition to the unlocked condition is performed in association with reading, with a second RFID reader different from the RFID reader of the user device, the RFID tag of the article.

Clause 34. The computer program product according to clause 31 wherein opening the authenticator application product includes accessing the authenticator application product stored on the user device.

Clause 35. The computer program product of clause 31 wherein opening the authenticator application product includes accessing the authenticator application product stored on one or more remote host databases.

Clause 36. The computer program product according to clause 31 wherein the computer-executable instructions further causes a device to:

pair the RFID tag of the article with a second account different from the first-mentioned account.

Clause 37. The computer program product according to clause 31 wherein the computer-executable instructions further causes a device to:
read first and second RFID tags associated with the article to obtain first and second UIDS; and
compare the first and second UIDs with the list of authentic UIDs stored in the accessible database to determine the authenticity of the article.

Clause 38. The computer program product according to clause 31 wherein the article comprises one of alcohol goods, clothing, accessories, eyewear, jewelry, furniture, electronics or cosmetics.

Clause 39. A system for authenticating a product comprising:
an RFID tag coupled to a product, the RFID tag comprising a UID, a first updateable state and a second updateable state, wherein the first updateable state comprises one of a locked and unlocked state, and wherein the second state comprises one of a paired and unpaired state;
a database storing the UID;
a first RFID reader configured to change the first updateable state from the locked state to the unlocked state;
a second RFID reader configured to read and store the UID of the RFID tag and pair the RFID tag with information stored within an application installed on a personal mobile device of a user;
a computing device configured to communicate with the database over a network and verify the existence of the UID of the RFID tag within the database, and to communicate with a user a result of the verification.

Clause 40. The system according to clause 39, wherein the first RFID reader and the second RFID reader comprise the same RFID reader.

Clause 41. A method for authenticating a product comprising:
providing an RFID tag on a product;
reading, on a first RFID reader, a UID and a first updateable state of the RFID tag;
updating the first updateable state of the RFID tag from a locked state to an unlocked state;
comparing, via network communication, the UID of the RFID tag with a list of authentic UIDs on a remote database;
reading, on a second RFID reader, the UID of the RFID tag via an application stored on a mobile device of a user, and storing the UID of the RFID tag within memory of the application; and
communicating, via the network, the UID and at least one identifying information of the user.

### VII. Rules of Interpretation & General Definitions

Throughout the description herein and unless otherwise specified, the following terms may include and/or encompass the example meanings provided. These terms and illustrative example meanings are provided to clarify the language selected to describe embodiments both in the specification and in the appended points of focus, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments. A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required. Although a product may be described as including a plurality of components, aspects, qualities, characteristics and/or features, that does not indicate that all of the plurality are essential or required. Various other embodiments within the scope of the described invention(s) include other products that omit some or all of the described plurality. A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the clauses. Accordingly, the clauses are intended to cover all such equivalents.

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise. Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A reference to “another embodiment” in describing an embodiment does not imply that the referenced embodiment is mutually exclusive with another embodiment (e.g., an embodiment described before the referenced embodiment), unless expressly specified otherwise. The indefinite articles “a” and “an,” as used herein in the specification and in the clauses, unless clearly indicated to the contrary, should be understood to mean “at least one” or “one or more”.

The phrase “and/or,” as used herein in the specification and in the clauses, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or clauses are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods, as known to those of ordinary skill in the art. When directly and explicitly distinguishing embodiments from discussed prior art, the embodiment numbers are not approximating unless the word “about” is recited. Whenever “substantially,” “approximately,” “about,” or similar language is explicitly used in combination with a specific value, variations up to and including ten percent (10%) of that value are intended, unless explicitly stated otherwise.

Directions and other relative references may be used to facilitate discussion of the drawings and principles herein, but are not intended to be limiting. For example, certain terms may be used such as “inner,” “outer”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same. Similarly, while the terms “horizontal” and “vertical” may be utilized herein, such terms may refer to any normal geometric planes regardless of their orientation with respect to true horizontal or vertical directions (e.g., with respect to the vector of gravitational acceleration).

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Where a limitation of a first clause would cover one of a feature as well as more than one of a feature (e.g., a limitation such as “at least one widget” covers one widget as well as more than one widget), and where in a second clause that depends on the first clause, the second clause uses a definite article “the” to refer to the limitation (e.g., “the widget”), this does not imply that the first clause covers only one of the feature, and this does not imply that the second clause covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a clause to a ‘step’or ‘steps’of a process has sufficient antecedent basis.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining and the like. The term “computing” as utilized herein may generally refer to any number, sequence, and/or type of electronic processing activities performed by an electronic device, such as, but not limited to looking up (e.g., accessing a lookup table or array), calculating (e.g., utilizing multiple numeric values in accordance with a mathematic formula), deriving, and/or defining.

The terms “including”, “comprising” and variations thereof mean “including but not limited to”, unless expressly specified otherwise. As used herein, “comprising” means “including,” and the singular forms “a” or “an” or “the” include plural references unless the context clearly dictates otherwise. The term “or” refers to a single element of stated alternative elements or a combination of two or more elements, unless the context clearly indicates otherwise.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as ultra-wideband (UWB) radio, Bluetooth™M, Wi-Fi, TDMA, CDMA, 3G, 4G, 4G LTE, 5G, etc.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

Embodiments of the disclosed subject matter can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

### VIII. Conclusion

Although the system has been illustrated in the figures and discussed in detail herein, embodiments of the disclosed subject matter are not limited thereto. In practical implementations, embodiments may include additional components or other variations beyond those illustrated. Accordingly, embodiments of the disclosed subject matter are not limited to the particular types of products, RFID tag attachment mechanisms, retailer categories and configurations specifically illustrated and described herein.

Any of the features illustrated or described with respect to one of FIGS. 1-7 and the Clauses can be combined with features illustrated or described with respect to any other of FIGS. 1-7 and the Clauses to provide systems, methods, devices, and embodiments not otherwise illustrated or specifically described herein. All features described herein are independent of one another and, except where structurally impossible, can be used in combination with any other feature described herein.

The present disclosure provides, to one of ordinary skill in the art, an enabling description of several embodiments and/or inventions. Some of these embodiments and/or inventions may not be claimed in the present application, but may nevertheless be claimed in one or more continuing applications that clause the benefit of priority of the present application. Applicant intends to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the present disclosure.

What is claimed is:

1. A system for authenticating an article, comprising:
at least one RFID reader;
a point-of-sale (POS) terminal communicatively coupled to the RFID reader;
at least one processor;
a memory storing a program for directing the processor, the processor operable with the program to:
receive, at the POS terminal and via the RFID reader, a unique identifier (UID) comprising information corresponding to an article, wherein the UID was read by the RFID reader from at least one radio frequency identification (RFID) tag associated with the article;
confirming an authenticity and availability for purchase of the article by comparing the UID with a list of authentic UIDs stored in an accessible database;
changing, only if the confirming is successful, a first state of the at least one RFID tag from a locked state to an unlocked state, thereby allowing a pairing of the RFID tag with a user account of a user attempting to purchase the article; and
facilitating the pairing of the UID of the RFID tag with the user account.

2. The system according to claim 1, wherein the processor being operable with the program to facilitate the pairing comprises coordinating with a software application on a mobile device of the user.

3. The system according to claim 1, wherein the processor being operable with the program to facilitate the pairing comprises the processor being operable with the program to facilitate an updating of a second state of the at least one RFID tag from an unpaired state to a paired state.

4. The system according to claim 1, wherein the processor being operable with the program to facilitate the pairing comprises the processor being operable with the program to store, in the accessible database, an indication of the user account in association with the UID of the at least one RFID tag.

5. The system according to claim 1, wherein the processor being operable with the program to facilitate the pairing comprises the processor being operable with the program to unpair the UID of the at least one RFID tag, as stored in the accessible database, from an account of a provider of the article and instead pair it with the user account.

6. The system according to claim 1, wherein the processor being operable with the program to facilitate the pairing comprises the processor being operable with the program to generate a confirmation code, the confirmation code indicating that the article is being purchased by the user from an authorized retailer and being for provision to the user to enter into a software application on the mobile device of the user.

7. The system according to claim 1, wherein the processor being operable with the program to confirm comprises the processor being operable with the program to access a record of the accessible database to confirm that the UID is not currently paired with any user account.

8. The system according to claim 1, wherein the processor is further operable with the program to:
verify, prior to the confirming, that the first state of the at least one RFID tag is in a locked state and only performing the confirming if the verifying is successful, otherwise outputting an error message to an operator of the at least one RFID reader.

9. The system according to claim 1, wherein the processor is further operable with the program to:
prevent a purchase of the article by the user if the confirming is not successful.

10. The system according to claim 1, wherein the processor being operable with the program to prevent the purchase comprises the processor causing a transaction mode of the POS terminal to be disabled.

11. The system according to claim 1, wherein the processor and program is a processor and program of the RFID reader.

12. The system according to claim 1, wherein the processor and program is a processor and program of the POS terminal.

13. An RFID tag comprising:
a first binary and changeable state that can be set to either a locked status or an unlocked status; and
a second binary and changeable state that can be set to either a paired status or an unpaired status,
wherein the second state cannot be changed from an unpaired status to a paired status unless the first state is set to the unlocked status.

14. The RFID tag according to claim 13, wherein the first state is only operable to be changed by a certified retailer of an article to which the RFID tag corresponds.

15. The RFID tag according to claim 14, wherein the first state is only operable to be changed from a locked status to an unlocked status upon receiving a predetermined signal from a system of the certified retailer.

16. A method for authenticating an article, comprising:
obtaining an article having at least one radio frequency identification (RFID) tag associated therewith, the at least one RFID tag having a unique identifier (UID) comprising information representative of the article;
reading the at least one RFID tag to obtain the UID;
transitioning the at least one RFID tag from a locked condition to an unlocked condition;
comparing the UID with a list of authentic UIDs stored in an accessible database to determine an authenticity of the article; and
transitioning the at least one RFID tag from an unpaired mode to a pairing mode to enable the RFID tag to be paired with a user account by an authenticity verification software product;
where the method is performed by one or more processors coupled to memory.

17. The method according to claim 16 wherein reading the RFID tag is performed with an RFID reader.

18. The method according to claim 16 wherein transitioning the RFID tag from a locked condition to an unlocked condition is performed by an RFID reader.

19. The method according to claim 16 further including:
reading first and second RFID tags associated with the article to obtain first and second UIDS; and
comparing the first and second UIDs with the list of authentic UIDs stored in the accessible database to determine the authenticity of the article.

20. The method according to claim 19 wherein the first RFID is associated with the article and the second RFID is associated with packaging of the article.
